(19) United States
(12) Patent Application Publication
(10) Pub. No.: US 2012/0029798 A1
(43) Pub. Date: Feb. 2, 2012

(54) Signal Control Apparatus and Method with Vehicle Detection

(75) Inventor: David Dodd Miller, Austin, TX (US)

(73) Assignee: Siemens Industry, Inc., Alpharetta, GA (US)

(21) Appl. No.: 12/848,279

(22) Filed: Aug. 2, 2010

(51) Int. Cl. G06F 19/00

(52) U.S. Cl. 701/117

(57) ABSTRACT

A roadside equipment (RSE) system that can be used for controlling traffic signals and other equipment and corresponding method. A method includes wirelessly receiving vehicle data by an RSE system and from an onboard equipment (OBE) system connected to a vehicle. The vehicle data includes location data, time data, and vehicle identification data related to the vehicle. The method includes determining a most recent location of the vehicle by the RSE system and from the vehicle data, comparing the most recent location of the vehicle to a previous location of the vehicle, and producing a control signal based on the comparison.

### CROSS-REFERENCE TO OTHER APPLICATION

This application has some subject matter in common with commonly-assigned, concurrently-filed U.S. patent application Ser. Nos. ______ for “System and Method for Lane-Specific Vehicle Detection and ______ Control” and for “System and Method for Traffic-Control Phase Change Warnings”, both of which are hereby incorporated by reference.

### TECHNICAL FIELD

The present disclosure is directed, in general, to improved traffic control systems and methods.

### BACKGROUND OF THE DISCLOSURE

For reasons related to safety, efficiency, environmental concerns, and other issues, improved traffic control and monitoring systems are desirable.

### SUMMARY OF THE DISCLOSURE

Various disclosed embodiments include a roadside equipment (RSE) system that can be used for controlling traffic signals and other equipment and corresponding method. A method includes wirelessly receiving vehicle data by an RSE system and from an onboard equipment (OBE) system connected to a vehicle. The vehicle data includes location data, time data, and vehicle identification data related to the vehicle. The method includes determining a most recent location of the vehicle by the RSE system and from the vehicle data, comparing the most recent location of the vehicle to a previous location of the vehicle, and producing a control signal based on the comparison.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a simplified block diagram of an onboard equipment system in accordance with disclosed embodiments;

FIG. 2 depicts a simplified block diagram of a roadside equipment system in accordance with disclosed embodiments; and

FIGS. 3 and 4 depict processes in accordance with disclosed embodiments.

### DETAILED DESCRIPTION

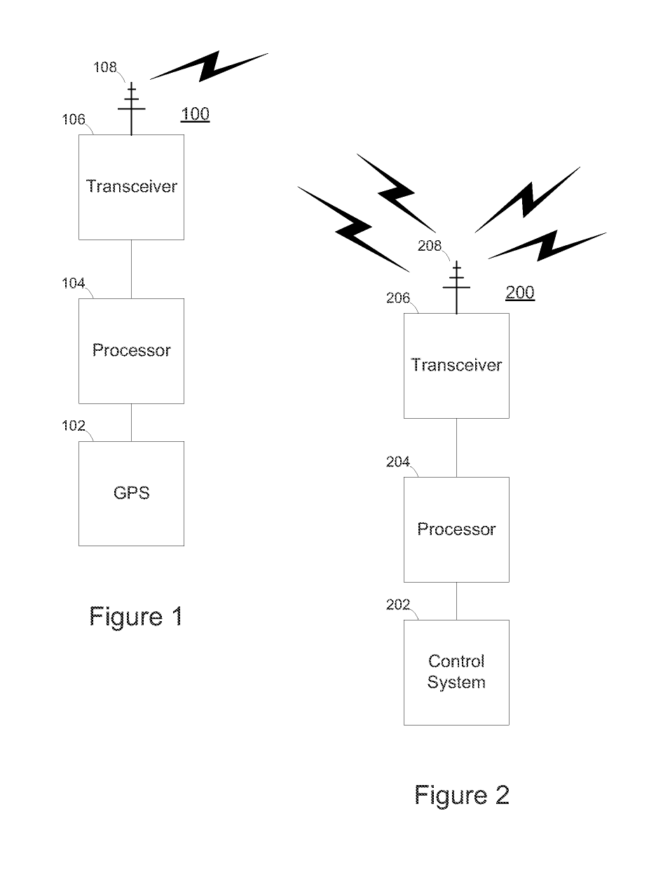

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Efficient traffic management can be accomplished using intelligent traffic control systems that are able to detect vehicles in the area of a traffic control device. Disclosed embodiments include systems and methods in which individual vehicles broadcast information to be received and processed by the traffic control system.

A number of methods have been employed to detect vehicles approaching a signalized intersection. These include inductive loop detection and video detection.

An inductive loop detector is a metal detector, similar to those used to find coins on the beach. In this case, the coil of wire is inserted into slots cut into the pavement. Each end of the coil is connected to the detector circuitry that is usually installed inside the controller cabinet located near the street. The loop creates electrical inductance, which is used in by the detector circuitry to create an oscillation frequency. When a vehicle containing metal drives over the inductive loop, the metal disrupts the magnetic field above the loop, causing the loop inductance to change. The change in inductance causes the frequency of the detector circuitry to change. The frequency change is sensed by the detector circuitry, which then switches the output, signaling the signal controller that a vehicle is present.

One or more inductive loops are cut into the pavement to sense vehicles from the various approaches to the intersection. Inductive loop detectors are inexpensive to purchase, but are expensive to install and maintain. Loops break as the roadway expands in hot weather, and traffic must be detoured during installation and repair. Another disadvantage is that an inductive loop detects vehicles in a specific “detection zone” above the loop. Two or more inductive loop detectors per approach are required to obtain vehicle speeds.

Video vehicle detector technology, like inductive loop detectors, senses vehicles in preset detection zones. Video vehicle detectors use video cameras and imaging software instead of wire loops cut into the roadway surface. In many cases, a video camera is mounted overhead and opposite to the approaching traffic. A cable from each overhead camera delivers video to video detection circuitry installed in the roadside equipment (RSE) cabinet.

To set up detection zones, the video detection system sends one or more frames of video to a display device, such as a TV set or laptop computer. Using a pointing device such as a mouse, one or more detection zones are drawn on the video image of the pavement by a user. At that point, the display device may be removed.

For detection, the camera then sends video frames at a preset rate continuously to the detection circuitry. The video imaging software scans the video frames, seeking changes in the video pixels within in the detection zone. When the video imaging software detects a vehicle within the zone, an output is switched in the same fashion as the output of a loop detector. Video detection is inexpensive to install, as wire loops are not cut into the pavement, and traffic does not have to be detoured while a “bucket truck” is used to install the overhead cameras. In addition, video detection has a low maintenance cost, with no loops to break when the pavement expands with temperature changes.

However, video detection has two serious disadvantages. First, video is much more expensive than inductive loop detection. Second, video detection does not work in adverse weather, such as fog, heavy rain and heavy snowfall, when traffic control can be most important and the driver may be in the greatest potential danger.

Other vehicle detection technologies include radar, infrared, and piezo-electric detection. Radar detection is similar to the radar “speed guns” used by the highway patrol. Radar can detect approaching vehicles via the Doppler affect, whereby a radio wave is transmitted and the reflection back from the vehicle measured. Radar is not widely-used for vehicle detection because the precise location and numbers of vehicles approaching the intersection are not evident.

Infrared detection is also used in speed enforcement, but uses a reflected light beam to detect vehicles, instead of radio waves. Therefore, infrared is not widely-used for vehicle detection for the same reasons. In a piezo-electric detections system, piezo current is generated when crystal structure is compressed. For example, a quartz watch uses a crystal to generate the precise frequency that is divided down into seconds, hours, days, months and years. When the crystal is compressed, the frequency changes according to the amount of compression, which is the basis of electronic scales. Piezo sensors can be placed in the roadway to detect vehicles at precise locations. Piezo is not widely-used for vehicle detection, as several sensors must be used to cover the same area as an inductive loop. Additionally, the Piezo sensors must be cut into the pavement to avoid such hazards as snow-plows, and so have the same high installation costs as inductive loops.

Disclosed embodiments depart from traditional vehicle detection, in which equipment at the signalized intersection attempts to detect each approaching vehicle. Instead, according to disclosed embodiments, each vehicle approaching the intersection transmits its location to the signal controller.

The systems and methods disclosed herein include various means of using onboard equipment (OBE) installed or used in a vehicle and roadside equipment (RSE) that detects the vehicle by communicating with the OBE. Of course, in various embodiments, some or all of the components of the RSE could be physically located other than “roadside”, such as in a cabinet, traffic controller, signal head, or otherwise. The RSE can be used to control many different types of traffic equipments, and can be used to collect and send data to a central monitoring station for further analysis or action, using common networking and communication techniques.

For the onboard equipment, global positioning system (GPS) and radio technology can be used. GPS was originally developed by the US Military, and consists of an array of stationary satellites that transmits the precise time of day and other data. By processing the signals received from several satellites, a GPS receiver accurately and precisely computes latitude and longitude, such as within 3 feet of error. In areas obscured from satellite reception, such as tunnels, the GPS position can be sent to GPS receivers via stationary beacons.

Several license-free radio technologies exist, such as Radio Frequency Identification (RFID), Spread Spectrum, Institute of Electrical and Electronic Engineers (IEEE) standard 802.11, direct radio-frequency broadcast, and others. Those of skill in the art will recognize that different ones of these technologies, and other wireless technologies, can be used for different specific implementations so as to operate with sufficient distance and data rates to accommodate the RSE requirements described herein.

FIG. 1 depicts a simplified block diagram of an onboard equipment system 100 in accordance with disclosed embodiments. In this diagram, processor 104 is connected between a GPS receiver 102 and a transceiver 106, such that the processor 104 receives the geographic location of the GPS receiver 102 and precise time of day, updated continually or periodically. The GPS receiver 102 receives the geographic location and time from the GPS and then sends it to the processor 104, along with a vehicle identification. The processor 104 then sends the geographic location and time, along with a vehicle identification, to the transceiver 106, which transmits the geographic location, time and vehicle identifier via antenna 108 to the RSE.

In this manner, the RSE receives continuous updates of the geographic location at a precise time for every vehicle approaching from each direction that is within the broadcast area of the respective transceivers 106.

Those of skill in the art will recognize that not all other details are shown in this simplified diagram. For example, GPS receiver 102 may also be connected to an automobile navigation system, an emergency-communication system, or to other components of the automobile. The GPS receiver 102, processor 104, and transceiver 106 will each also be connected to a vehicle power source, and may each be connected to other systems and components of the vehicle. The processor 104, and other components, can be connected to read and write to a storage such as volatile and non-volatile memory, magnetic, optical, or solid-state media, or other storage devices. The antenna 108 may be dedicated to transceiver 106, or may be connected to be shared with other components. Transceiver 106 itself can be only a wireless transmitter, although of course it receives data from the processor 104, or can also be a wireless receiver. Processor 104 may be configured to perform only the processes described herein, or can also be configured to perform other processes for the operation and management the vehicle. The various components of FIG. 1 could be constructed as separate elements connected to communicate with each other, or two or more of these components could be integrated into a single device.

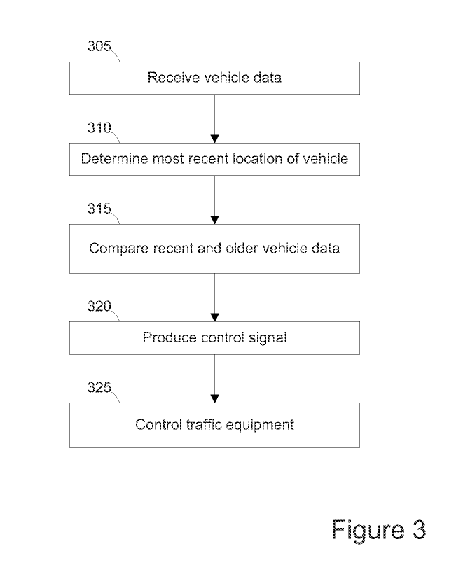

FIG. 2 depicts a simplified block diagram of a roadside equipment system 200, in accordance with disclosed embodiments, that can be configured to perform processes as described herein. In this diagram, processor 204 is connected between a control system 202 and a transceiver 206. The transceiver 206 receives the geographic location, time information, and vehicle identification data from multiple OBE transceivers 106 that includes the location data and corresponding time data for multiple uniquely-identified vehicles, updated continually or periodically. The transceiver 206 receives this data from the vehicles and then sends it to the processor 204. The processor 104 then sends the geographic location and time to the control system 202, which can use it for traffic control and management processes, as described in more detail herein.

Those of skill in the art will recognize that not all other details are shown in this simplified diagram. For example, control system 202, processor 204, and transceiver 206 will each also be connected to a power source, and may each be connected to other systems and components of the RSE. The processor 204, and other components, can be connected to read and write to a storage such as volatile and non-volatile memory, magnetic, optical, or solid-state media, or other storage devices. The antenna 208 may be dedicated to transceiver 206, or may be connected to be shared with other components. Transceiver 206 itself can be only a wireless receiver, although of course it transmits data to the processor 204, or can also be a wireless transmitter. Processor 204 may be configured to perform only the processes described herein, or can also be configured to perform other processes for the operation and management the RSE. The various components of FIG. 2 could be constructed as separate elements connected to communicate with each other, or two or more of these components could be integrated into a single device. In particular, processor 204 can be an integral part of the control system 202, and perform many or all of the other functions of the RSE.

Disclosed processes include commissioning and operation processes, and include phase one and phase two operations processes.

Commissioning: Commissioning is performed when the RSE is first installed, and can be re-performed at a subsequent times as well. Commissioning eliminates the need to cut inductive loops in the pavement and also eliminates the need to install cameras overhead or to draw detection zones on a video display, as previously described.

RSE commissioning, in some embodiments, includes RSE location, roadway lane geometry, and determination of detection zones.

RSE location is the process of programming the RSE location with the location of the RSE or the traffic equipment that is to be used as the “base” location with regard to vehicle location. In the case of using the RSE as the base location, once installed in the roadside cabinet, the RSE is programmed with its geographic location. This can be accomplished, for example. by placing an OBE near the RSE. The RSE is then given a command to read the OBE geographic location, and to store that location in the RSE processor memory. This is but one example method to record the RSE location. Other methods might include simply entering the RSE location on via a keypad, laptop computer or from the traffic management center via communications lines. Of course, when other equipment or another location is used as the base location, that geographic location is used instead.

Roadway Lane Geometry: Next, RSE can be programmed with the legitimate roadway areas, in order to ignore foreign receptions from the surrounding area that do not originate from the roadway. This is a simple process that can be accomplished by recording the geographical locations of a single “trusted” OBE.

For example, the one “trusted” OBE could be turned ON and driven in each lane of each approach to the intersection, and will transmit its locations as it travels each lane. The RSE will receive and store these locations as valid locations for operation. This is but one method to record roadway lane geometry. Other methods might include simply entering the geographical boundaries via a keypad, laptop computer or from the traffic management center via communications lines.

Determination of Detection Zones: Detection zones used in phase one operations are analogous to the video detection zones-described earlier. But, instead of installing video cameras and drawing the zones using a mouse and video display, RSE detection zones can be established during the Roadway Lane Geometry process described above.

While the “trusted” OBE is being driven in each lane of each approach to the intersection, a “zone start” and “zone end” key is pressed on the “trusted” OBE at the desired locations in the roadway. The “trusted” OBE responds by sending the geographical locations for the start and end of each of the detection zones to the RSE. The RSE can receive and store these locations, and thereafter know the range of locations that correspond to each detection zone in each lane in all relevant directions.

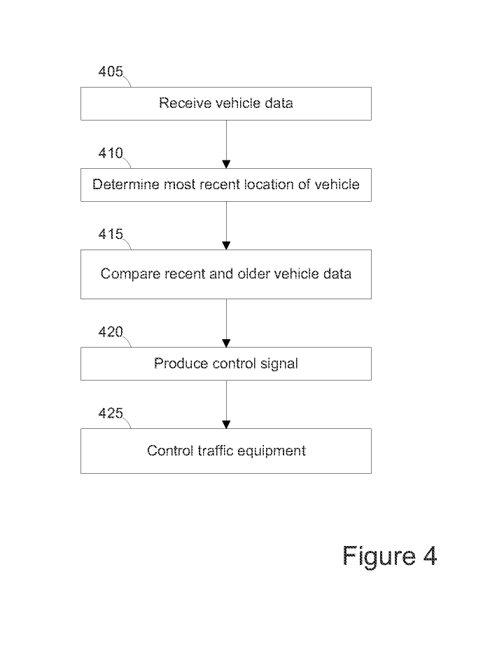

FIG. 3 depicts a flowchart of a process for phase one detection in accordance with disclosed embodiments. This process can replace existing Inductive Loop detectors and existing Video Detectors, and can be used with existing signal controllers as the control system 202. In some embodiments, the processor 204 includes outputs connected to the detector inputs of existing signal controllers used as the control system 202.

After commissioning, RSE wirelessly receives vehicle data from OBE in nearby vehicles (step 305). The vehicle data includes location data, time data, and vehicle identification data. The vehicle data, in some embodiments, includes at least two different data sets including location data, time data, and vehicle identification data for the same vehicle, referred to herein as “first vehicle data” and “second vehicle data” with respect to the order in which the data is received, where the first vehicle data is received by the RSE from a specific vehicle before the second vehicle data is received by the RSE from the same vehicle, having the same vehicle identifier. In a typical case, the first vehicle data will represent the older or previous location of the vehicle, and the second vehicle data will represent the current, most recent, or subsequent location of the vehicle.

Other data can be included with the vehicle data, but there is some advantage to limiting the amount of data transmitted so as to minimize the size of the transmissions being received, and to so avoid interference and other problems with larger data transmissions.

The system determines the most recent location of the vehicle from the second vehicle data (step 310). This can be performed by the RSE processor 204.

The system compares the second vehicle data to the first vehicle data (step 315). This can be performed by the RSE processor 204, and can include directly comparing the most recent location of the vehicle, based on the second vehicle data, to the previous location of the vehicle, based on the first vehicle data.

Based on the comparison and the second location data, the system produces a control signal (step 320). This can be performed by the RSE processor 204, and the control signal can be output from the processor to the control system 202.

The control system 202 can then control traffic equipment (step 325), such as traffic signals, pedestrian signals, signage or other indicators, or other equipment based on the control signal.

For example, if the second vehicle data indicates a location within a detection zone, the processor 204 can output a control signal that corresponds to that detection zone switches an appropriate signal controller detector input of control system 202.

Likewise, if the second vehicle data indicates a location on the opposite side of a detection zone than that indicated by the first vehicle data, the processor 204 can output a control signal that corresponds to that detection zone and switches the appropriate signal controller detector input of control system 202.

Similarly, if the second vehicle data indicates a location that is on the same side of the detection zone as that indicated by the first vehicle data, or if the second vehicle data indicates a location that is outside of the roadway lane geometry, the processor 204 can output a control signal that corresponds to that detection zone and does not switch the controller detector input.

The process of FIG. 3 can be performed continually as each vehicle enters the vicinity of the RSE and the RSE is able to receive the vehicle data from the OBE of each vehicle, and will typically be performed for multiple vehicles simultaneously. In some embodiments, only the first and second location data for each vehicle is stored and processed, and as new vehicle data is received from a particular vehicle, the new vehicle data is treated as the “second” vehicle data, the original “second” vehicle data is treated as the first vehicle data, and the original “first” vehicle data can be discarded. In other embodiments, the vehicle data can be stored for further processing and analysis; in some cases, the vehicle identifiers can be discarded or anonymized to protect driver privacy. In some embodiments, collected vehicle data can also be transmitted to another location for processing, using any conventional means including Internet Protocol communications either wired or wirelessly.

FIG. 4 depicts a flowchart of a process for phase two detection in accordance with disclosed embodiments. This process can replace or supplement detection zones with an arrival prediction process that can be performed by the control system 202. In some cases, the traffic signal controller itself acts as the control system 202 described herein, in addition to performing typical signal control functions.

In this example, and in other alternate embodiments, processor communicates directly with the signal controller (acting as control system 202), instead of hardwired connections to the detector inputs of the signal controller as in the example above. For example, the RSE processor 204 might include an Ethernet port connected to the traffic signal controller.

The system receives the first vehicle data and the second vehicle data (step 405). Note that in this example, the RSE receives the vehicle data via transceiver 206, and can perform the steps described below. Alternately, after being received via the transceiver 206, the vehicle data is passed to and received by the control system 202, which can perform the steps described below.

The system stores the first vehicle data and the second vehicle data (step 410), in by the processor 204, the control system 202, or both.

The system determines the estimated time of arrival (ETA) of each vehicle to the intersection (or other base location) using the first vehicle data and the second vehicle data. This step can include determining the vehicle speed, the travel time of the vehicle to the intersection or other base location, and, from those, the estimated time of arrival to the intersection or other base location. The vehicle speed can be calculated, for example, using the equation:

$${V}_{s} = \frac{( {L}_{2} - {L}_{1} )}{( {T}_{2} - {T}_{1} )}$$

where

Vₛ represents the vehicle speed;

L₂ represents the location of the vehicle in the second (later) vehicle data;

L₁ represents the location of the vehicle in the first (earlier) vehicle data;

T₂ represents the time data of the vehicle in the second (later) vehicle data; and

T₁ represents the time data of the vehicle in the first (earlier) vehicle data.

The travel time of the vehicle to the intersection or other base location can be calculated, for example, using the equation:

$${T}_{1} = \frac{( {L}_{1} - {L}_{2} )}{{V}_{s}}$$

where

T₁ represents the travel time of the vehicle to the intersection or other base location;

L₁ represents the location of the intersection or other base location;

L₂ represents the location of the vehicle in the second (later) vehicle data; and

Vₛ represents the vehicle speed.

The estimated time of arrival of the vehicle to the intersection or other base location can be calculated, for example, using the equation:

ETA=T₁+T_{D}

where
ETA represents estimated time of arrival of the vehicle to the intersection or other base location;
T₁ represents the travel time of the vehicle to the intersection or other base location; and
T_{D} represents the current time of day.

Of course, the exemplary equations above apply to the simple case of lanes leading straight from the vehicle to the RSE. More complex lane shapes are handled by applying the above equations in piecewise form to the Roadway Lane Geometry that was recorded during Commissioning, as described above.

Using the received vehicle data, and the calculation methods described above, the system computes an ETA for every vehicle approaching the intersection.

Based in part on the ETA of one or more approaching vehicles, the system can control the signal or other device for the most efficient and/or safe operation of the intersection or roadway, such as controlling the GREEN time of the traffic signals to accommodate greatest number of ETAs. For example, during low traffic volumes with few vehicles arriving at the same time, each vehicle can be granted a GREEN signal at arrival as a “first come, first served” control strategy such that no vehicle stops. As the traffic volume increases to the point that several vehicles will be arriving at the same time, the vehicle with the highest priority can be granted GREEN at arrival, such as ambulance superseding private vehicles. As the traffic volume increases above a predetermined value, the control strategy can switch from “first come, first served” to a “coordinated” strategy based on forming a dense traffic volume into “green platoons” that progress through green lights at the speed limit.

Vehicle priority can be determined, for example, by using vehicle identification data that includes a priority code, flag, or other information that identifies the priority level of the vehicle. The system can then control the signal or other device based on the priority of one or more approaching vehicles, or according to varying traffic conditions such as traffic volume, in combination with or instead of based on the location comparisons.

In other embodiments, the processor 104 of the OBE calculates and transmits the vehicle speed from the data from the GPS 102. The vehicle speed can be transmitted by the OBE 100 with the vehicle data, and then used in the processes above by the RSE 200, either directly in the calculation of the ETA, or to verify the vehicle speed calculated by the RSE.

The process of FIG. 4 can be performed continually as each vehicle enters the vicinity of the RSE and the RSE is able to receive the vehicle data from the OBE of each vehicle, and will typically be performed for multiple vehicles simultaneously.

Those skilled in the art will recognize that, for simplicity and clarity, the full structure and operation of all systems suitable for use with the present disclosure is not being depicted or described herein. Instead, only so much of an OBE and RSE system as is unique to the present disclosure or necessary for an understanding of the present disclosure is depicted and described. The remainder of the construction and operation of the systems disclosed herein may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of a instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method for traffic control, comprising:
wirelessly receiving vehicle data by a roadside equipment (RSE) system and from an onboard equipment (OBE) system connected to a vehicle, the vehicle data including location data, time data, and vehicle identification data related to the vehicle;
determining a most recent location of the vehicle by the RSE system and from the vehicle data;
comparing the most recent location of the vehicle to a previous location of the vehicle; and
producing a control signal based on the comparison.

2. The method of claim 1, wherein the vehicle data includes first vehicle data and second vehicle data, the first vehicle data indicating location data and time data for the previous location and the second vehicle data indicating location data and time data for the most recent location.

3. The method of claim 1, wherein comparing the most recent location of the vehicle to a previous location of the vehicle includes comparing first vehicle data received at a first time with second vehicle data received at a subsequent time, the first vehicle data and second vehicle data having the same vehicle identification data.

4. The method of claim 1, wherein the control signal is used to control the operation of traffic equipment.

5. The method of claim 1, wherein if most recent location of the vehicle is within a detection zone, the control signal switches a signal controller detector input of an RSE control system.

6. The method of claim 1, wherein the method is performed repeatedly and simultaneously as additional vehicle data is received.

7. The method of claim 1, wherein as additional vehicle data is received, at least some older vehicle data with the same vehicle identifier is discarded.

8. The method of claim 1, wherein the vehicle data also includes vehicle speed information.

9. The method of claim 1, wherein the RSE system also determines an estimated time of arrival of a vehicle indicated by the vehicle identifier to a base location.

10. The method of claim 9, wherein the estimated time of arrival is determined according to the distance between the most recent vehicle location and a vehicle speed.

11. The method of claim 9, wherein the control signal controls traffic equipment based in part on the estimated time of arrival.

12. The method of claim 1, wherein the OBE system includes a global positioning system receiver and a wireless transmitter capable of communicating with the RSE system.

13. The method of claim 1, wherein the control signal is also based on a vehicle priority.

14. The method of claim 1, wherein the control signal is also based on traffic conditions.

15. A roadside equipment (RSE) system comprising at least a processor and a wireless receiver, the RSE system configured to perform the steps of:
wirelessly receiving vehicle data by the wireless receiver from an onboard equipment (OBE) system connected to a vehicle, the vehicle data including location data, time data, and vehicle identification data related to the vehicle;
determining a most recent location of the vehicle by the processor and from the vehicle data;
comparing the most recent location of the vehicle to a previous location of the vehicle by the processor; and
producing a control signal based on the comparison.

16. The RSE system of claim 15, wherein the vehicle data includes first vehicle data and second vehicle data, the first vehicle data indicating location data and time data for the previous location and the second vehicle data indicating location data and time data for the most recent location.

17. The RSE system of claim 15, wherein comparing the most recent location of the vehicle to a previous location of the vehicle includes comparing first vehicle data received at a first time with second vehicle data received at a subsequent time, the first vehicle data and second vehicle data having the same vehicle identification data.

18. The RSE system of claim 15, wherein the control signal is used to control the operation of traffic equipment.

19. The RSE system of claim 15, wherein if most recent location of the vehicle is within a detection zone, the control signal switches a signal controller detector input of a control system.

20. The RSE system of claim 15, wherein the vehicle data also includes vehicle speed information.

21. The RSE system of claim 15, wherein the RSE system is also configured to perform the step of determining an estimated time of arrival of a vehicle indicated by the vehicle identifier to a base location and to control traffic equipment based in part on the estimated time of arrival.

22. The RSE system of claim 15, wherein the OBE system includes a global positioning system receiver and a wireless transmitter capable of communicating with the RSE system.

23. The RSE system of claim 15, wherein the control signal is also based on a vehicle priority.

24. The RSE system of claim 15, wherein the control signal is also based on traffic conditions.
